(19) United States
(12) Patent Application Publication
(10) Pub. No.: US 2010/0035494 A1
(43) Pub. Date: Feb. 11, 2010

(54) HIGHLY THERMALLY CONDUCTIVE ACRYLIC ADHESIVE SHEET

(75) Inventors: Takuya Okada, Gunma (JP); Keiji Takano, Gunma (JP); Masami Yamashita, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Denki Kagaku Kogyo Kabushiki Kaisha, Chuo-ku (JP)

(21) Appl. No.: 12/443,591

(22) PCT Filed: Sep. 27, 2007
(86) PCT No.: PCT/JP07/68868

§ 371 Date: Apr. 27, 2009

(30) Foreign Application Priority Data
Sep. 29, 2006 (JP) 2006-267955

(51) Int. Cl. B32B 27/30; C09J 7/00; C09J 11/04; C09J 133/08; C08J 5/18; C08L 31/02; C08K 3/22; C08K 3/10; C08F 2/46

(52) U.S. Cl. 442/136; 428/354; 428/344; 442/149; 524/556; 524/430; 524/437; 522/182

(57) ABSTRACT

To provide a thermally conductive acrylic sheet having a high temperature conductivity and also a good adhesion characteristic.

A double-sided, thermally conductive acrylic adhesive sheet, which is produced from a raw material mixture comprising (a) a monomer: an acrylate or methacrylate having a C₂₋₁₂ alkyl group, (b) a monomer: an acrylic monomer which is represented by a formula (1) but which is different from the monomer (a), (c) a polythiol and (d) an inorganic powder, wherein the content of the inorganic powder in the raw material mixture is from 30 to 70 vol %, and the maximum particle diameter of the inorganic powder is from 5 to 70% of the thickness of the sheet.

### TECHNICAL FIELD

The present invention relates to a thermally conductive acrylic sheet having a double-sided adhesion and to a printed board, a heat sink and a heat pipe using the sheet.

### BACKGROUND ART

Heretofore, as a method for fixing various components in electronic devices, a method of screwing or a method of fixing by an adhesive is available, but such a method has a problem of taking time and effort. On the other hand, with respect to a method of fixing by a double-sided adhesive sheet, the reliability of its fixation may be inferior to the method of screwing or fixing by an adhesive, but since it is relatively simple in its operation, it is often used from the viewpoint of working efficiency in a case where no strong fixation is required.

On the other hand, in recent years, along with miniaturization and high integration of electronic devices, the density of heat generated from various components in the electronic devices has increased, and it has been important how to release such heat to outside. In such a case, thermal conduction via the double-sided adhesive tape used for fixing such various components, becomes an important heat dissipation path. In such a case, adhesion at a high temperature, namely, a high temperature retention becomes important.

Usually, a common adhesive tape is basically an organic material, whereby its thermal conductivity is as low as about 0.2 W/mK (Non-Patent Document 1). Therefore, in order to increase the thermal conductivity, it has been proposed to use one having an inorganic filler having a relatively high thermal conduction incorporated (Patent Document 1).

Patent Document 1: JP-A-2006-089579

Non-Patent Document 1: KAGAKU BINRAN 3rd edition, applied version, P809 (compiled by The Chemical Society of Japan, MARUZEN CO., LTD. 1980)

### DISCLOSURE OF THE INVENTION

### Object to be Accomplished by the Invention

The present invention is one to provide a thermally conductive acrylic sheet having a high thermal conductivity and a good adhesive characteristic.

### Means to Accomplish the Object

That is, the present invention provides the following.

(1) A double-sided, thermally conductive acrylic adhesive sheet, which is produced from a raw material mixture comprising (a) a monomer: an acrylate or methacrylate having a C₂₋₁₂ alkyl group, (b) a monomer: an acrylic monomer which is represented by a formula (1) but which is different from the monomer (a), (c) a polythiol and (d) an inorganic powder, wherein the content of the inorganic powder in the raw material mixture is from 30 to 70 vol %, and the maximum particle diameter of the inorganic powder is from 5 to 70% of the thickness of the sheet:

CH₂═CR₁CO—(OR₂)—OR₃ (1)

wherein R₁ is hydrogen or a methyl group, R₂ is an alkylene group, R₃ is hydrogen, a C₁₋₁₂ alkyl group or a substituted or unsubstituted phenyl group, and n is an integer of from 0 to 12.
(2) A double-sided, thermally conductive acrylic adhesive sheet, which is produced from a raw material mixture comprising (a) a monomer: an acrylate or methacrylate having a C₂₋₁₂ alkyl group, (b) a monomer: an acrylic monomer which is represented by a formula (1) but which is different from the monomer (a), (c) a polythiol, (d) an inorganic powder and (e) a flame retardant, wherein the content of the inorganic powder in the raw material mixture is from 30 to 70 vol %, and the maximum particle diameter of the inorganic powder is from 5 to 70% of the thickness of a sheet to be formed:

CH₂═CR₁CO—(OR₂)ₙ—OR₃ (1)

wherein R₁ is hydrogen or a methyl group, R₂ is an alkylene group, R₃ is hydrogen, a C₁₋₁₂ alkyl group or a substituted or unsubstituted phenyl group, and n is an integer of from 0 to 12.
(3) The double-sided, thermally conductive acrylic adhesive sheet according to (1) or (2), wherein the monomer (b) contains acrylic acid, and the content of acrylic acid is from 1 to 15 vol %, based on the total of the monomer (a) and the monomer (b).
(4) The double-sided, thermally conductive acrylic adhesive sheet according to any one of (1) to (3), wherein the inorganic powder (d) is made of alumina and/or an aluminum hydroxide.
(5) The double-sided, thermally conductive acrylic adhesive sheet according to any one of (2) to (4), wherein the flame retardant (e) is of a metal hydroxide type and/or phosphate type.
(6) The double-sided, thermally conductive acrylic adhesive sheet according to any one of (1) to (5), wherein the polythiol (c) is from 0.04 to 5.0 vol % based on the total of the monomer (a) and the monomer (b).
(7) The double-sided, thermally conductive acrylic adhesive sheet according to any one of (1) to (6), wherein the monomer (b) is photoreactive, and the raw material mixture contains a photopolymerization initiator.
(8) The double-sided, thermally conductive acrylic adhesive sheet according to (7), wherein the content of the photopolymerization initiator is from 0.04 to 2.0 vol %, based on the total of the monomer (a) and the monomer (b).
(9) The double-sided, thermally conductive acrylic adhesive sheet according to any one of (1) to (8), which has a high temperature retention at 80° C. or higher under a 1 kg load on an aluminum plate in accordance with JIS-Z-1541.
(10) The double-sided, thermally conductive acrylic adhesive sheet according to any one of (1) to (9), which contains a reinforcing substrate.
(11) The double-sided, thermally conductive acrylic adhesive sheet according to (10), wherein the reinforcing substrate is a glass cloth.
(12) The double-sided, thermally conductive acrylic adhesive sheet according to (10), wherein the reinforcing substrate is a metal foil.
(13) A printed board containing the double-sided, thermally conductive acrylic adhesive sheet as defined in any of (1) to (12).
(14) A heat sink containing the double-sided, thermally conductive acrylic adhesive sheet as defined in any of (1) to (12).
(15) A heat pipe containing the double-side, thermally conductive acrylic adhesive sheet as defined in any of (1) to (12).

### EFFECT OF THE INVENTION

The present invention has an effect to effectively transfer heat, while fixing components, etc. which generate heat.

### BEST MODE FOR CARRYING OUT THE INVENTION

In the present invention, (a) a monomer: an acrylate or methacrylate having a C₂₋₁₂ alkyl group, is a C₂₋₁₂ alkyl acrylate or alkyl methacrylate. The monomer (a) may, for example, be ethyl acrylate, propyl acrylate, butyl acrylate, 2-ethylhexyl acrylate, octyl acrylate, isooctyl acrylate, decyl acrylate, decyl methacrylate or dodecyl methacrylate. Among them, 2-ethylhexyl acrylate or butyl acrylate is preferred.

The monomer (b) in the double-sided, thermally conductive acrylic adhesive sheet of the present invention is an acrylic monomer which is represented by a formula (1), but which is different from the monomer (a):

CH₂═CR₁CO—(OR₂)ₙ—OR₃ (1)

In the formula, R₁ is hydrogen or a methyl group. R₂ is an alkylene group, R₃ is hydrogen, a C₁₋₁₂ alkyl group or a substituted or unsubstituted phenyl group, and n is an integer of from 0 to 12. The alkylene group as R₂ may be an ethylene group, a propylene group, a butylene group, or the like, and an ethylene group, a propylene group or a butylene group is preferred. The monomer (b) may, for example, be acrylic acid, 2-hydroxyethyl acrylate, 2-hydroxypropyl acrylate, 4-hydroxybutyl acrylate, 2-methoxyethyl acrylate, ethoxyethyl acrylate, ethyl carbitol acrylate, phenoxyethyl acrylate, nonyl phenoxyethyl acrylate, 2-ethylhexyl carbitol acrylate, a polyethylene glycol monoacrylate having at most 12 ethylene glycol repeating units, an ethoxy polyethylene glycol monoacrylate having at most 12 ethylene glycol repeating units, a phenoxy polyethylene glycol monoacrylate having at most 12 ethylene glycol repeating units, a polypropylene glycol monoacrylate having at most 12 propylene glycol repeating units, a methoxypolypropylene glycol monoacrylate having at most 12 propylene glycol repeating units, an ethoxypolypropylene glycol monoacrylate having at most 12 propylene glycol units, a phenoxypolypropylene glycol monoacrylate having at most 12 propylene glycol repeating units, a polybutylene glycol monoacrylate having at most 12 butylene glycol repeating units, a polyethylene glycol monomethacrylate having at most 12 ethylene glycol repeating units, a polypropylene glycol monomethacrylate having at most 12 propylene glycol repeating units, or a polybutylene glycol monomethacrylate having at most 12 butylene glycol repeating units. However, the monomer (b) is not restricted thereto. Among them, the monomer (b) is particularly preferably acrylic acid, a polypropylene glycol monoacrylate having at most 12 propylene glycol repeating units or 4-hydroxybutyl acrylate, or a mixture thereof.

The monomer (a) used in the present invention has a function to constitute the main framework of the sheet of the present invention having an adhesive characteristic, and the monomer (b) has a function to improve the adhesion at a high temperature. The proportion of the monomer (b) in the monomer mixture of the monomer (a) and the monomer (b), is preferably from 1 to 20 vol %. Further, the blend proportion of (a)+(b) is preferably from 25 to 70 vol % in the monomer mixture having constituting materials (a)+(b)+(c)+(d) put together.

The monomer (b) preferably contains acrylic acid and the proportion of acrylic acid is preferably from 1 to 15 vol % in the monomer mixture of the monomer (a) and the monomer (b). If the proportion is less than 1 vol %, an agglomeration-imparting effect by acrylic acid becomes small, whereby the high temperature retention decreases.

If the proportion exceeds 15 vol %, the entire sheet becomes rigid, whereby the high temperature retention also decreases. The proportion of acrylic acid in the monomer mixture of the monomer (a) and the monomer (b) is more preferably from 3 to 10 vol %.

The polythiol (c) used in the present invention is a mercaptan compound having at least 2 mercapto groups (—SH), and it is a material which is represented by the formula (2), formula (3), formula (4) or formula (5) and which has an average molecular weight of from 50 to 15,000. Here, “an average molecular weight” means “a weight average molecular weight.”

Z(-SH)ₘ (2)

Z[-O—CO—(CH₂)ₚ—SH]ₘ (3)

Z[-O—(C₃H₆O)_{q}—CH₂CH(OH)CH₂SH]ₘ (4)

In each of the formulae, Z is an organic residual group having m functional groups, m is an integer of from 2 to 6, and each of p and q is an integer of from 0 to 3. Further, a polythiol wherein the organic residual group Z is one represented by the formula (5), formula (6), formula (7) or formula (8), is preferred:

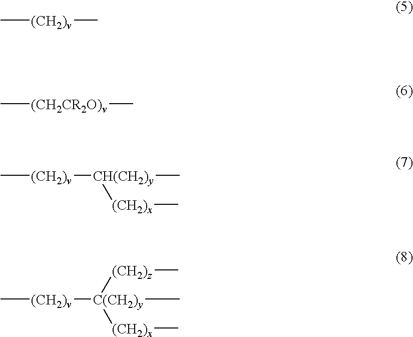

Here, R₂ is an alkylene group such as an ethylene group, a propylene group or a butylene group, each of v and w is an integer of from 1 to 6, and each of x, y and z is an integer of from 0 to 6.

In the double-sided, thermally conductive acrylic adhesive sheet of the present invention, the ratio of the constituting raw materials (a), (b) and (c), is such that based on the total of (a)+(b), (c) is preferably in a range of from 0.01 to 7.0 vol %, further preferably from 0.04 to 5.0 vol %. If (c) is less than 0.01 vol %, the molecular weight of an acrylic matrix constituting the sheet becomes large, and the adhesion decreases, whereby the high temperature retention decreases. On the other hand, if (c) exceeds 7.0 vol %, the molecular weight becomes too low, and the strength as a sheet becomes low, whereby such also deteriorates the high temperature retention.

Other than the constituting components (a), (b) and (c), the double-sided, thermally conductive acrylic adhesive sheet of the present invention may contain a copolymerizable crosslinking component such as a known polymerizable compound, a known polyfunctional vinyl compound, a polyfunctional acrylate or a polyfunctional acrylic compound.

To the double-sided, thermally conductive acrylic adhesive sheet of the present invention, it is possible to add a known additive in an optional amount, as the case requires, as long as there is no influence during curing. The additive includes, for example, various additives to control the viscosity or stickiness, other modifiers, age registers, heat stabilizers and colorants.

The curing method for producing the double-sided, thermally conductive acrylic adhesive sheet of the present invention may be carried out by a polymerization method such as heat polymerization by means of a proper heat polymerization initiator, or polymerization using a heat polymerization initiator and a curing accelerator.

As a suitable heat polymerization initiator, it is possible to use an azo compound or an organic peroxide. The useful azo compound may be 2,2′-azobisisobutyronitrile, 2,2′-azobis(2,4-dimethylvaleronitrile) or 2,2′-azobis(2-methylbutylnitrile). The useful organic peroxide may, for example, be methyl ethyl ketone peroxide, cyclohexanone peroxide, acetyl acetone peroxide, 1,1-di(tertiary butyl peroxy)butane, n-butyl 4,4-di(tertiary butyl peroxy)valerate, 2,2-di(4,4-di(tertiary butyl peroxy)cyclohexyl)propane, p-menthane hydroperoxide, diisopropylbenzene hydroperoxide, 1,1,3,3-tetramethylbutyl hydroperoxide, cumene hydroperoxide, tertiary butyl hydroperoxide, di(2-tertiary butyl peroxyisopropyl)benzene, dicumyl peroxide, 2,5-dimethyl-2,5-di(tertiary butyl peroxy)hexane, tertiary butyl cumyl peroxide, ditertiary butyl peroxide, ditertiary hexyl peroxide, 2,5-dimethyl-2,5-di(tertiary butyl peroxy)hexyne-3, diisobutyryl peroxide, di(3,5,5-trimethylhexanoyl) peroxide, di-n-octanoyl peroxide, dilauroyl peroxide, disuccinic acid peroxide, dibenzoyl peroxide, di(4-methylbenzoyl) peroxide, di-n-propyl peroxydicarbonate, diisopropyl peroxydicarbonate, di(4-tertiary butyl cyclohexyl) peroxydicarbonate, di(2-ethylhexyl) peroxydicarbonate, cumyl peroxyneodecanoate, tertiary butyl peroxyneodecanoate, tertiary butyl peroxypivalate, 2,5-dimethyl-2,5-di(2-ethylhexanoyl peroxy)hexane, tertiary butyl peroxy-2-ethylhexanoate, tertiary butyl peroxyisobutylate, tertiary butyl peroxymaleic acid, tertiary butyl peroxy-3,5,5-trimethylhexanoate, di-tertiary butyl peroxyhexahydrotelephthalate, tertiary butyl peroxyisopropyl monocarbonate, tertiary butyl peroxy-2-ethylhexyl monocarbonate, 2,5-dimethyl-2,5-di(benzoyl peroxy)hexane, tertiary butyl peroxyacetate or tertiary butyl peroxybenzoate, but it is not limited thereto. The heat polymerization initiator is especially preferably 2,2-azobisisobutyronitrile or methyl ethyl ketone peroxide.

As a suitable curing accelerator, it is possible to use a known curing accelerator which reacts with the heat polymerization initiator and generates radicals. A representative curing accelerator may, for example, be a tertiary amine, a thiourea derivative or a transition metal salt. The tertiary amine may, for example, be triethylamine, tripropylamine, tributylamine or N,N-dimethyl-p-toluidine. The thiourea derivative may, for example, be 2-mercaptobenzimidazole, methyl thiourea, dibutyl thiourea, tetramethyl thiourea or ethylene thiourea. The transition metal salt may, for example, be cobalt naphthenate, copper naphthenate or vanadyl acetylacetonate.

The double-sided, thermally conductive acrylic adhesive sheet of the present invention is preferably polymerized by photopolymerization by means of a suitable photopolymerization initiator from the viewpoint of controlling the curing reaction. The suitable photopolymerization initiator may be benzophenone, p-methoxybenzophenone, 4,4-bis dimethyl aminobenzophenone, xanthone, thioxanthone, chlorothioxanthone, m-chloroacetone, propiophenone, anthraquinone, benzoin methyl ether, benzoin ethyl ether, benzoisopropyl ether, benzoin butyl ether, benzyl, 2,2-dimethoxy-1,2-diphenylethan-1-one, acetophenone, 2,2-diethoxyacetophenone or 2-hydroxy-2,2-dimethylacetophenone, but it is not limited thereto. The photopolymerization initiator is preferably benzophenone.

The inorganic powder (d) to be used in the present invention may, for example, be a metal oxide such as aluminum oxide (alumina) or titanium dioxide, a nitride such as aluminum nitride, boron nitride or silicon nitride, silicon carbide, or aluminum hydroxide, but it is not limited thereto. They may be used alone or in combination as a mixture of some of them. A thermally conductive sheet is usually required to have flame retardance, and a metal hydroxide such as aluminum hydroxide having also a flame retardant effect is one of preferred thermally conductive particles. Further, when the sheet is prepared by a photo-curing polymerization method, the inorganic powder (d) is preferably aluminum oxide (alumina) and/or aluminum hydroxide, particularly preferably a combination of alumina and aluminum hydroxide, by taking penetration of light into a consideration. When alumina and aluminum hydroxide are used in combination, the blend ratio of alumina to aluminum hydroxide (alumina/aluminum hydroxide) is preferably from 0.3 to 2.0 by a volume ratio.

The blend ratio of such inorganic powder is preferably from 30 to 70 vol %. If it is less than 30 vol %, sufficient thermal conductivity cannot be obtained, and if it is more than 70 vol %, not only the adhesive characteristic becomes deteriorated, but also the sheet becomes brittle, and the handling efficiency becomes also deteriorated. The content of the inorganic powder is more preferably from 50 to 65 vol %.

The particle diameter of such inorganic powder particles needs to be controlled based on the thickness of a sheet to be prepared, and the maximum particle diameter is preferably in a range of from 5 to 70% of the thickness of the sheet. If it is less than 5%, sufficient thermal conductivity cannot be obtained. On the other hand, if it is more than 70%, irregularities are formed on the surface of the sheet, whereby the adhesive characteristic will be deteriorated. The maximum particle diameter of the inorganic powder particles is preferably from 10 to 70%, particularly preferably from 10 to 60%, of the thickness of the sheet.

The double-sided, thermally conductive acrylic adhesive sheet of the present invention has a thickness of preferably from 10 to 3,000 μm, particularly preferably from 30 to 1,000 μm. Further, with respect to the double-sided, thermally conductive acrylic adhesive sheet of the present invention, it is possible to impart flame retardance to it by using a flame retardant (e). The flame retardant to be used is preferably of a metal hydroxide type or phosphate type in consideration of an environmental problem or a photopolymerization case. A halogen type flame retardant has a problem of being influential over the environment, and in the case of a phosphorus type flame retardant, red phosphorus has a low light transmittance and thus has a problem in photopolymerization. Among the metal hydroxide type and phosphate type, the flame retardant (e) is particularly preferably aluminum hydroxide or an organic phosphorus compound, Exolit OP-930 (manufactured by Clariant K.K.).

Further, with respect to the adhesive characteristic of the double-sided, thermally conductive acrylic adhesive sheet of the present invention, it preferably has a high temperature retention at 60° C. or higher under a load of 1 kg on an aluminum plate, further preferably a high temperature retention at 80° C. or higher, in consideration of a case where it is used at a heat generating part of a personal computer.

A reinforcing substrate is preferably a glass cloth or a metal foil in consideration of the cost and the influence on the thermal conductivity. Especially when the metal foil is used, it is also possible to expect a shielding effect against electromagnetic waves. As the reinforcing metal foil, a copper foil, an aluminum foil or a stainless steel foil is particularly preferred.

Further, the double-sided, thermally conductive acrylic adhesive sheet of the present invention is preferably in a form reinforced by laminating it with a substrate having higher strength, from the viewpoint of handling efficiency. The substrate may be a non-woven cloth, a glass cloth, a glass chopped strand, a carbon fiber, a metal fiber or a metal foil, in addition to films made of various resins such as polyester. The non-woven cloth or the glass cloth has a reinforcing effect with a light weight, and its thermal conductivity can also be secured by incorporating a component of the double-sided, thermally conductive acrylic adhesive sheet also in such a substrate. In such a case, as the glass cloth, it is possible to use one made of various raw materials such as chopped strand. From the carbon fiber or the metal foil, it is possible to expect a heat spread effect in an in-plane direction of the substrate by the thermal conductivity and also a shielding effect against electromagnetic waves. The metal fiber or carbon fiber to be used in such a case is not particularly limited, and it is possible to use one made of various raw materials as the case requires.

Further, for the metal foil, it is possible to use various metals such as Al, Cu and Sn. Further, a similar effect can be expected also by applying a material having electrical conductivity or high thermal conductivity, such as metal or carbon, on the surface of the non-woven cloth or the glass cloth. Further, when the metal foil is used, by using a metal foil with a slit, it is also possible to reduce the rigidity of the double-sided, thermally conductive acrylic adhesive sheet laminated with the substrate. In the case of lamination with various substrates, the double-sided, thermally conductive acrylic adhesive sheet may be laminated on one side or both sides of such a substrate, or a plurality of substrates may be laminated on one side or both sides of the double-sided, thermally conductive acrylic adhesive sheet. Further, in order to improve the wettability of the double-sided, thermally conductive acrylic adhesive sheet with the substrate, the necessary substrate surface may be treated with various coupling agents, etc.

On the other hand, when the sheet having a double-sided adhesion is difficult to be handled, or when a difference in adhesion is desired between both sides to be boned, it is possible to combine the sheet e.g. by lamination with a sheet barely having adhesion such as a metal foil or a polyester film or with a sheet having a different level of adhesion. In such a case, since the double-sided, thermally conductive adhesion tape of the present invention has a good adhesion characteristic, it can be handled without a problem of interlayer peeling.

The method for mixing the constituting raw materials, is not particularly limited, and a common mixer such as an universal mixer, a planetary mixer, a rotary and revolutionary mixer, a Henschel mixer, a kneader, a ball mill or a mixing roll, is used, although manual mixing is also possible with a small amount.

At the time of mixing, it is possible to suitably add various media such as water, toluene and alcohol in order to make the mixture suitable for the particular molding method.

As a process for producing the double-sided, thermally conductive acrylic adhesive sheet of the present invention, it is possible to use various conventionally known processes. That is, the sheet can be produced in such a manner that a raw material mixture comprising the above monomer (a), monomer (b), polythiol (c), inorganic powder (d), and further preferably flame retardant (e), is formed into a slurry by suitably using the above medium as the case requires, and the slurry is applied on a suitable sheet material by a coating method or a doctor blade method, or the raw material mixture can be molded into a sheet by an extrusion molding method, an injection molding method or a press molding method.

Further, in order to reinforce the sheet of the double-sided, thermally conductive acrylic adhesive sheet of the present invention, it is possible to laminate the sheet with a reinforcing substrate by using a known laminating method such as a common laminating method or pressing method, since the sheet of the present invention has double-sided adhesion. However, the reinforced sheet may be directly prepared by using such a reinforcing substrate as a substrate to be used for a coating method.

The double-sided, thermally conductive acrylic adhesive sheet of the present invention can be made into an electronic component having high heat releasing property by bonding it on a printed board, a heat sink, a heat pipe, etc.; by bonding to a printed board one wherein the double-sided thermally conductive acrylic adhesive sheet of the present invention is bonded on a heat sink; or by bonding to a printed board one wherein the double-sided, thermally conductive acrylic adhesive sheet of the present invention is bonded on a heat pipe.

### EXAMPLES

Now, the present invention will be described in further detail with reference to Examples, but it should be understood that the present invention is by no means restricted thereto.

### Examples 1 to 4 and 6 to 11, Comparative Examples 3 and 4

2-Ethylhexyl acrylate or butyl acrylate as the monomer (a), 2-hydroxybutyl acrylate, tripropylene glycol monoacrylate or acrylic acid, as the monomer (b), and others such as, triethylene glycol dimercaptan (DMDO manufactured by Maruzen Chemical Co., Ltd.), acrylic acid (manufactured by TOAGOSEI CO., LTD.), a photopolymerization initiator (IRGACURE 500 manufactured by Ciba Specialty Chemicals K.K.), alumina (DAW10 manufactured by Denki Kagaku Kogyo Kabushiki Kaisha; the maximum particle diameter: 30 μm) and aluminum hydroxide (B103ST manufactured by Nippon Light Metal Company, Ltd.; the maximum particle diameter: 50 μm) were mixed in the volume ratio as shown in Table 1 or 2 by a rotary and revolutionary mixer to prepare a slurry mixture. By such a slurry, a coated film having a prescribed thickness was prepared on a PET (polyethylene terephthalate) substrate having a thickness of 100 μm by a doctor blade method, and on the coated film, a similar PET film was placed, followed by irradiation with ultraviolet ray to obtain a sheet molded product having a thickness as shown in Table 1. Here, the maximum particle diameter of the inorganic powder was the maximum particle diameter detected by measuring the particle size distribution by means of Microtrac MT3200 manufactured by NIKKISO CO., LTD. When multiple inorganic powders were used, the largest value among measured results of the respective inorganic powders was taken as the maximum particle diameter.

With respect to the high temperature retention of the obtained sheet, the retention at 80° C. on an aluminum plate was evaluated in accordance with the measuring method described in JIS-A-1541. Further, the thermal conductivity was obtained in such a manner that after the sheet was screwed between a TO-3 type copper heater case and a copper plate so that its thickness was compressed by 10%, an electrical power of 15 W was applied to the heater case until the temperature difference between the heater case and the copper plate became constant, and such a temperature difference was measured and the thermal resistance was calculated from the following formula (9):

Thermal resistance(° C./W)=Temperature difference (° C.)/applied voltage(W) (9)

From the value of the obtained thermal resistance, the thermal conductivity was calculated from the following formula (10). Further, the sample thickness here is the thickness obtained at the time of measuring the thermal resistance (the thickness when the sheet was screwed so that its thickness was compressed by 10% to measure the thermal resistance). Further, the thermal transfer area is 0.0006 m² which is the thermal transfer area of TO-3 type:

$$Thermal conductivity ( W \text{/} m \cdot K ) = \frac{Sample thickness ( m )}{Thermal resistance ( °C . \text{/} W ) \times Thermal transfer area ( {m}^{2} )} \qquad ( 10 )$$

The evaluation results are shown in Tables 1 and 2. Further, with respect to Comparative Example 4, the sheet became extremely brittle and could not be evaluated. In Tables 1 and 2, the high temperature retention was one evaluated in such a manner that a 1 kg weight was suspended against an aluminum plate via a double-sided, thermally conductive adhesive sheet with an area of 25 mm×25 mm, and X indicates that the weight fell within 2 hours, and ◯ indicates that it was retained without falling.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
|---|---|---|---|---|---|---|---|---|---|---|---|---|
| Formulation | 2-Ethylhexyl | 37.4 | | 30.3 | 30.3 | 37.4 | 40 | 37.7 | 37.5 | 54.5 | 37.5 | 37.1 |
| (parts | acrylate | | | | | | | | | | | |
| by | Butyl acrylate | | 38.6 | | | | | | | | | |
| volume) | Tripropylene glycol | | | 1.9 | | | | | | | | |
| | monoacrylate | | | | | | | | | | | |
| | 4-Hydroxybutyl | | | | 1.9 | | | | | | | |
| | acrylate | | | | | | | | | | | |
| | Acrylic acid | 2.8 | 2.9 | 2.2 | 2.2 | 2.8 | 0.3 | 6.1 | 2.8 | 4.1 | 2.8 | 2.8 |
| | Polythiol (DMDO) | 0.3 | 0.3 | 0.2 | 0.2 | 0.3 | 0.3 | 0.3 | 0 | 3.5 | 0.3 | 0.3 |
| | Irg500 | 0.2 | 0.2 | 0.2 | 0.2 | 0.2 | 0.2 | 0.2 | 0.2 | 0.3 | 0 | 1 |
| | (photopolymerization | | | | | | | | | | | |
| | initiator) | | | | | | | | | | | |
| | Alumina DAW-45 | | | | | 25.8 | | | | | | |
| | Alumina DAW-10 | 25.8 | 37.2 | 22.1 | 22.1 | | 25.8 | 24.3 | 25.9 | 37.6 | 25.8 | 25.6 |
| | Alumina LS130 | | | | | | | | | | | |
| | (Pacific Rundum | | | | | | | | | | | |
| | Co., Ltd.) | | | | | | | | | | | |
| | Aluminum hydroxide | 33.5 | 20.8 | 43.1 | 43.1 | 33.5 | 33.5 | 31.5 | 33.6 | | 33.6 | 33.2 |
| | B-303ST | | | | | | | | | | | |
| Evaluation | Thickness of sheet | 100 | 100 | 100 | 100 | 250 | 100 | 100 | 100 | 100 | 100 | 100 |
| results | (μm) | | | | | | | | | | | |
| | High temperature | ◯ | ◯ | ◯ | ◯ | ◯ | ◯ | ◯ | ◯ | ◯ | ◯ | ◯ |
| | retention (80° C.) | | | | | | | | | | | |
| | Thermally | 1.2 | 1.2 | 1.2 | 1.2 | 1.6 | 1.3 | 1 | 1 | 1.3 | 1.1 | 1.3 |
| | conductivity (W/mK) | | | | | | | | | | | |

TABLE 2

| | | Comp. | Comp. | Comp. | Comp. |
|---|---|---|---|---|---|
| | | Ex. 1 | Ex. 2 | Ex. 3 | Ex. 4 |
| Formulatian | 2-Ethylhexyl | 37.4 | 37.4 | 65.1 | 24.7 |
| (parts by volume) | acrylate | | | | |
| | Butyl acrylate | | | | |
| | Tripropylene | | | | |
| | glycol | | | | |
| | monoacrylate | | | | |
| | 4-Hydroxybutyl | | | | |
| | acrylate | | | | |
| | Acrylic acid | 2.8 | 2.8 | 4.9 | 1.9 |
| | Polythiol (DMDO) | 0.3 | 0.3 | 0.5 | 0.2 |
| | Irg500 | 0.2 | 0.2 | 0.3 | 0.1 |
| | (photopolymerizatian | | | | |
| | initiator) | | | | |
| | Alumina DAW-45 | 25.8 | | | |
| | Alumina DAW-10 | | | | 51 |
| | Alumina LS130 | | 25.8 | | |
| | (Pacific Rundum | | | | |
| | Co., Ltd.) | | | | |
| | Aluminum hydroxide | 33.5 | 33.5 | 29.2 | 22.1 |
| | B-303ST | | | | |
| Evaluatian | Thickness of sheet | 100 | 100 | 100 | Not |
| results | (μm) | | | | measurable |
| | High temperature | X | ◯ | ◯ | Not |
| | retention (80° C.) | | | | measurable |
| | Thermally | 1.6 | 0.6 | 0.5 | Not |
| | conductivity | | | | measurable |
| | (W/mK) | | | | |

### Example 5, Comparative Examples 1 and 2

A sheet molded product having the thickness shown in Table 1 or 2 was obtained in the same manner as in Example 1 except that as alumina, DAW45 (maximum particle diameter: 100 μm) manufactured by Denki Kagaku Kogyo Kabushiki Kaisha or LS130 (maximum particle diameter: 8 μm) manufactured by Pacific Rundum Co., Ltd. was used. Further, the thermal conductivity and the retention at 80° C. on an aluminum plate, of the obtained sheet were evaluated in the same manner as in Example 1. The results are shown in Tables 1 and 2.

### Example 12

The double-sided, thermally conductive acrylic sheet prepared in Example 1, was bonded on the backside of a printed board, and the resultant was bonded on an aluminum housing. The printed board was operated, and the temperature of the board surface was measured. The surface temperature decreased as compared with a case where a common double-sided adhesive sheet, (“Nice Tuck” manufactured by NICHIBAN CO., LTD.) was used instead of the double-sided, thermally conductive acrylic sheet.

### Example 13

The double-sided, thermally conductive acrylic sheet prepared in Example 1, was bonded on a heat sink, and the resultant was bonded on a printed board. The printed board was operated, and the temperature of the board surface was measured. The surface temperature decreased as compared with a case where a common double-sided adhesive sheet, (“Nice Tuck” manufactured by NICHIBAN CO., LTD.) was used instead of the double-sided, thermally conductive acrylic sheet.

### Example 14

The double-sided, thermally conductive acrylic sheet prepared in Example 1, was bonded on a heat pipe, and the resultant was bonded on a printed board. The printed board was operated, and the temperature of the board surface was measured. The surface temperature decreased as compared with a case where a common double-sided adhesive sheet, (“Nice Tuck” manufactured by NICHIBAN CO., LTD.) was used instead of the double-sided, thermally conductive acrylic sheet.

The tensile strength of the obtained sheet was measured in accordance with JIS K7127. Further, the adhesion with a substrate was measured in accordance with JIS Z0237. Further, in both measurements, TENSILON (manufactured by A&D Company, Limited) was used.

### Examples 15 to 20

Each substrate shown in Table 2 was immersed in the slurry used in the production in Example 1 for 3 minutes, and then, it was taken out and was irradiated with ultraviolet and cured in the same manner as in Example 1. Then, on each side of the resultant, the double-sided, thermally conductive adhesive tape prepared in Example 1 was laminated by using a laminator to prepare a sheet reinforced by the substrate. The results of evaluating each tensile strength and thermal conductivity are shown together in Table 3. It is evident that the tensile strength improved by the reinforcement by each substrate. During handling, there was no peeling between the double-sided, thermally conductive adhesive tape and the substrate, and the handling efficiency was good.

TABLE 3

| | | Ex. 15 | Ex. 16 | Ex. 17 | Ex. 18 | Ex. 19 | Ex. 20 |
|---|---|---|---|---|---|---|---|
| Laminate | Glass cloth (E06B2W358H, manufactured by | ◯ | | | | | |
| substrate | UNITIKA LTD.) | | | | | | |
| | Al foil (thickness: 30 μm, manufactured | | ◯ | | | | |
| | by FUKUDA FOIL & POWDER Co., Ltd.) | | | | | | |
| | Carbon fiber (GRANOC cloth, manufactured | | | ◯ | | | |
| | by Nippon Grafite Fiber Corporation) | | | | | | |
| | Stainless fiber (thickness: 20 μm, | | | | ◯ | | |
| | manufactured by Tomoegawa Co., Ltd.) | | | | | | |
| | Polyester nonwoven cloth (thickness: 50 μm, | | | | | ◯ | |
| | manufactured by TOYOBO CO., LTD.) | | | | | | |
| | PPS film (thickness: 25 μm, manufactured | | | | | | ◯ |
| | by TORAY INDUSTRIES, INC.) | | | | | | |
| Evaluation | Strength (MPa) | 25 | 13 | 10 | 7 | 6 | 30 |
| results | Thermal conductivity (W/mK) | 1.2 | 1.9 | 1.7 | 1.7 | 1 | 0.7 |

### INDUSTRIAL APPLICABILITY

The double-sided, thermally conductive acrylic adhesive sheet of the present invention is expected to be useful not only for an electronic component but also in a field which requires heat releasing property and adhesion.

The entire disclosure of Japanese Patent Application No. 2006-267955 filed on Sep. 29, 2006 including specification, claims and summary is incorporated herein by reference in its entirety.

1-16. (canceled)

17. A double-sided, thermally conductive acrylic adhesive sheet, which is produced from a raw material mixture comprising (a) a monomer component comprised of an acrylate or methacrylate monomer having a C₂₋₁₂ alkyl group, (b) a monomer component comprised of an acrylic monomer which is represented by formula (1) but which is different from monomer (a):
CH₂═CR₁CO—(OR₂)ₙ—OR₃ (1)
wherein R₁ is hydrogen or a methyl group, R₂ is an alkylene group, R₃ is hydrogen, a C₁₋₁₂ alkyl group or a substituted or unsubstituted phenyl group, and n is an integer ranging from 0 to 12, (c) a polythiol and (d) an inorganic powder, wherein the content of the inorganic powder in the raw material mixture ranges from 30 to 70 vol %, and the maximum particle diameter of the inorganic powder ranges from 5 to 70% of the thickness of the sheet

18. A double-sided, thermally conductive acrylic adhesive sheet, which is produced from a raw material mixture comprising (a) a monomer component comprised of an acrylate or methacrylate monomer having a C₂₋₁₂ alkyl group, (b) a monomer component comprised of an acrylic monomer which is represented by formula (1) but which is different from the monomer (a):
CH₂═CR₁CO—(OR₂)ₙ—OR₃ (1)
wherein R₁ is hydrogen or a methyl group, R₂ is an alkylene group, R₃ is hydrogen, a C₁₋₁₂ alkyl group or a substituted or unsubstituted phenyl group, and n is an integer of from 0 to 12, (c) a polythiol, (d) an inorganic powder and (e) a flame retardant, wherein the content of the inorganic powder in the raw material mixture ranges from 30 to 70 vol %, and the maximum particle diameter of the inorganic powder ranges from 5 to 70% of the thickness of a sheet to be formed.

19. The double-sided, thermally conductive acrylic adhesive sheet according to claim 17, wherein the monomer (b) contains acrylic acid, and the content of acrylic acid ranges from 1 to 15 vol %, based on the total of the monomer (a) and the monomer (b).

20. The double-sided, thermally conductive acrylic adhesive sheet according to claim 18, wherein the monomer (b) contains acrylic acid, and the content of acrylic acid ranges from 1 to 15 vol %, based on the total of the monomer (a) and the monomer (b).

21. The double-sided, thermally conductive acrylic adhesive sheet according to claim 17, wherein the inorganic powder (d) is made of alumina and/or an aluminum hydroxide.

22. The double-sided, thermally conductive acrylic adhesive sheet according to claim 18, wherein the inorganic powder (d) is made of alumina and/or an aluminum hydroxide.

23. The double-sided, thermally conductive acrylic adhesive sheet according to claim 18, wherein the flame retardant (e) is of a metal hydroxide and/or phosphate.

24. The double-sided, thermally conductive acrylic adhesive sheet according to claim 17, wherein the polythiol (c) ranges from 0.04 to 5.0 vol % based on the total of the monomer (a) and the monomer (b).

25. The double-sided, thermally conductive acrylic adhesive sheet according to claim 18, wherein the polythiol (c) ranges from 0.04 to 5.0 vol % based on the total of the monomer (a) and the monomer (b).

26. The double-sided, thermally conductive acrylic adhesive sheet according to claim 17, wherein the monomer (b) is photoreactive, and the raw material mixture contains a photopolymerization initiator.

27. The double-sided, thermally conductive acrylic adhesive sheet according to claim 18, wherein the monomer (b) is photoreactive, and the raw material mixture contains a photopolymerization initiator.

28. The double-sided, thermally conductive acrylic adhesive sheet according to claim 26, wherein the content of the photopolymerization initiator ranges from 0.04 to 2.0 vol %, based on the total of the monomer (a) and the monomer (b).

29. The double-sided, thermally conductive acrylic adhesive sheet according to claim 27, wherein the content of the photopolymerization initiator is from 0.04 to 2.0 vol %, based on the total of the monomer (a) and the monomer (b).

30. The double-sided, thermally conductive acrylic adhesive sheet according to claim 17, which has a high temperature retention at 80° C. or higher under a 1 kg load on an aluminum plate in accordance with JIS-Z-1541.

31. The double-sided, thermally conductive acrylic adhesive sheet according to claim 18, which has a high temperature retention at 80° C. or higher under a 1 kg load on an aluminum plate in accordance with JIS-Z-1541.

32. The double-sided, thermally conductive acrylic adhesive sheet according to claim 17, which contains a reinforcing substrate.

33. The double-sided, thermally conductive acrylic adhesive sheet according to claim 18, which contains a reinforcing substrate.

34. The double-sided, thermally conductive acrylic adhesive sheet according to claim 32, wherein the reinforcing substrate is a glass cloth.

35. The double-sided, thermally conductive acrylic adhesive sheet according to claim 33, wherein the reinforcing substrate is a glass cloth.

36. The double-sided, thermally conductive acrylic adhesive sheet according to claim 32, wherein the reinforcing substrate is a metal foil.

37. The double-sided, thermally conductive acrylic adhesive sheet according to claim 33, wherein the reinforcing substrate is a metal foil.

38. The double-sided, thermally conductive acrylic adhesive sheet according to claim 32, wherein the reinforcing substrate is a nonwoven fabric.

39. The double-sided, thermally conductive acrylic adhesive sheet according to claim 33, wherein the reinforcing substrate is a nonwoven fabric.

40. The double-sided, thermally conductive acrylic adhesive sheet according to claim 32, wherein the reinforcing substrate is a carbon fiber.

41. The double-sided, thermally conductive acrylic adhesive sheet according to claim 33, wherein the reinforcing substrate is a carbon fiber.

42. The double-sided, thermally conductive acrylic adhesive sheet according to claim 32, wherein the reinforcing substrate is a metal fiber.

43. The double-sided, thermally conductive acrylic adhesive sheet according to claim 33, wherein the reinforcing substrate is a metal fiber.

44. The double-sided, thermally conductive acrylic adhesive sheet according to claim 32, wherein the reinforcing substrate is a resin sheet having less adhesion.

45. The double-sided, thermally conductive acrylic adhesive sheet according to claim 33, wherein the reinforcing substrate is a resin sheet having less adhesion.
